(19) United States
(12) Patent Application Publication
(10) Pub. No.: US 2008/0028468 A1
(43) Pub. Date: Jan. 31, 2008

(54) METHOD AND APPARATUS FOR AUTOMATICALLY GENERATING SIGNATURES IN NETWORK SECURITY SYSTEMS

(76) Inventors: Sungwon YI, Seoul (KR); Hwa Shin MOON, Daejeon-city (KR); Jintae OH, Daejeon-city (KR); Jong Soo JANG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/774,699

(22) Filed: Jul. 9, 2007

(30) Foreign Application Priority Data
Jul. 28, 2006 (KR) 10-2006-0071654

(51) Int. Cl. G06F 11/30

(52) U.S. Cl. 726/23

(57) ABSTRACT

A method and apparatus for automatically generating a signature used in a security system are provided. The apparatus and method include a configuration for combining a plurality of substrings extracted from a packet and generating a substring set; a configuration for examining the attacking characteristic of a packet having a substring set and confirming whether or not the substring can be used as a signature for detecting an attacking packet; and a configuration for optimization so as to increase the distinction and storing efficiency of a signature.

### CROSS-REFERENCE TO RELATED PATENT APPLICATIONS

This application claims the benefit of Korean Patent Application No. 10-2006-0071654, filed on Jul. 28, 2006, in the Korean Intellectual Property Office, the disclosure of which is incorporated herein in its entirety by reference.

### BACKGROUND OF THE INVENTION

1. Field of the Invention

The present invention relates to method and apparatus for automatically generating a signature used in a security system, and more particularly, to a method and apparatus in which an attack, such as a worm or virus, is detected in real-time on a network, and unique characteristics (signature) of attacking packets are automatically generated, thereby protecting an object network from malicious users or programs.

2. Description of the Related Art

In order to establish network security, identifying a characteristic of attacking packets is first required. This characteristic of the attacking packets is registered as a signature, and if the registered signature is sensed in a received packet, a security policy corresponding to the signature is applied, thereby protecting the network from malicious users or programs.

Technology for extracting the characteristic of attacking packets on a network is mostly based on technologies for examining a resemblance between electronic documents including web documents on the Internet, or for classifying the electronic documents. Accordingly, previously developed techniques for extracting the characteristic of electronic documents will be explained in brief and then, how this technology is applied to networks will be explained.

In order to examine the resemblance between large amounts of electronic documents, first, the characteristic of each document needs to be briefly expressed. By comparing the thus simplified documents, the amount of computation required for examining the resemblance can be minimized.

In general, a method that is most widely used as the technique to determine the characteristics of documents is a Karp-Rabin fingerprinting technique based on a hash function. In this technique, one document is divided into substrings each of which having arbitrary bytes, and a hash value of each substring is calculated.

Next, in order to find same or similar documents in a database, the hash values calculated with respect to each document are compared. However, if the document is large, or the database is too big, the comparison of all hash values calculated with respect to one document becomes a major factor degrading the system performance.

In order to solve this problem, sampling is used. That is, instead of comparing all calculated hash values, only sampled hash values are compared using a verified sampling method, thereby obtaining a reliable result and also preventing degradation of the performance of the system.

Leading technologies for detecting attacking packets in a network and generating the signature of the packets based on the technologies, described above, for examining the resemblance of electronic documents or for classifying the document involve any of the following three techniques.

First, there is an Earlybird technique. In the Earlybird technique, a hash value is calculated using the Karp-Rabin fingerprinting technique. The calculated hash value is value-sampled (sampled to 1/64) and the frequency of the hash value is recorded in a separate table. The Earlybird again selects signatures frequently appearing on networks from among the hash values in this table, and examines the distribution of the addresses of the packets of the signatures, thereby generating a worm signature.

Secondly, there is an autograph technique. In the autograph technique, first, the traffic of an suspected attacking session from among sessions connected to a network, that is, the traffic of an unsuccessfully connected session, is stored and the contents of the packets are reassembled. In classification of suspected attacking sessions, abnormal traffic detection technologies, such as port scan detection, are mainly used, and the method of analyzing the assembled packet contents is similar to that of the Earlybird technique.

A major difference is that in the autograph technique the entire session, instead of individual packets, is combined and examined, and when substrings and hash values are extracted, a content-based payload partitioning (COPP) technique is used. Accordingly the payload occurring in the autograph technique has a variable size.

Finally, there is a polygraph technique extended from the autograph in order to apply the autograph to a polymorphic worm. The polygraph technique shares the basic structure with the autograph technique. However, unlike the previous two techniques, not just one substring is used as a signature, but a plurality of substrings are combined and used as one signature. According to the methods of combination, non-ordered combination-type signatures, ordered signatures, and statistical-method-based signatures are generated.

The autograph and polygraph techniques compensate for the problem of the Earlybird, by reassembling packets corresponding to a session. However, they have drawbacks in that implementation in a high-speed network is difficult due to the processing power required for session reassembly and memory access delays. Meanwhile, the Earlybird has a problem in detecting an attacking signature that can appear along two or more contiguous packets.

In general, the major characteristics that a signature should have are distinction and simplicity. That is, one signature should express only its object, and also, the style of expression should be simple. However, conventional technologies for generating network attacking signatures do not sufficiently satisfy these two characteristics.

First, a problem of conventional methods in terms of distinction, is that a predetermined block that can be commonly found in a plurality of sessions is liable to be registered as a signature of an attacking packet.

For example, most web traffic based on a hypertext transfer protocol (HTTP) may have a part in the front of a packet, which is widely used by a protocol, such as ‘GET_message”. Also, documents, such as pdf and postscript, have distinctive information used uniquely to each format, in the front parts of documents. When the usage frequency of packet contents is measured, these parts appear to have higher frequencies than other parts, and are liable to be registered as signatures.

Conventional methods are relatively free from the simplicity requirement because one signature is generated from one substring. However, there is a problem in that if a plurality of signatures are generated from one packet, it should be determined which one should be used as a signature. If this determination is not performed, a plurality of signatures are generated in relation to one attack, and management of these signatures becomes impossible. Accordingly, since verification of generated signatures requires a large amount of manual work, it is difficult to apply the signature in real-time. In addition, in the case of the polymorphic worm whose contents can be varied little by little due to propagation, it is liable to be missed in detection when conventional exact pattern matching technology is used.

Furthermore, in the case of current network intrusion detection and/or prevention systems, attacking signatures are generated mostly by manual work. Accordingly, the generation of signatures themselves is very difficult and real-time responding is also difficult. In comparison, the autograph or Earlybird methods automatically generate attacking signatures, thereby making real-time responding easier, but the reliability of the generated signatures is low.

### SUMMARY OF THE INVENTION

The present invention provides an apparatus and method of automatically generating an optimum signature for a security system, in which an attacking signature is automatically generated, thereby making real-time responding to network attacks easier, and at the same time, minimizing a detection error ratio and increasing the reliability of an attacking signature. Also generation, storage, management, and application of a signature can be performed easier.

According to an aspect of the present invention, there is provided an apparatus for automatically generating an optimum signature for a security system, the apparatus including: a substring set generation unit combining substrings appearing more than a predetermined number of times among a plurality of substrings extracted from a packet, and generating a substring set; a substring set confirmation unit examining whether or not the packet having the substring set has a characteristic of an attacking packet, and confirming whether or not the substring set can be used as a signature for detecting an attacking packet; and a signature optimization unit minimizing the size of the confirmed substring set, and increasing distinction and storage efficiency of the substring set as a signature.

According to another aspect of the present invention, there is provided a method of automatically generating an optimum signature for a security system, the method including: combining substrings appearing more than a predetermined number of times among a plurality of substrings extracted from a packet, and generating a substring set; examining whether or not the packet having the substring set has a characteristic of an attacking packet, and confirming whether or not the substring set can be used as a signature for detecting an attacking packet; and minimizing the size of the confirmed substring set, and increasing distinction and storage efficiency of the substring set as a signature, for optimization.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a major structure of an apparatus for automatically generating an optimum signature according to an embodiment of the present invention;

FIG. 2 is a detailed diagram of a structure of a substring set generation unit illustrated in FIG. 1 according to an embodiment of the present invention;

FIG. 3 is a flowchart illustrating a method of automatically generating an optimum signature according to an embodiment of the present invention;

FIG. 4 is a detailed flowchart illustrating a method of generating a substring set according to an embodiment of the present invention;

FIG. 5 is a flowchart illustrating a method of optimizing a signature according to an embodiment of the present invention;

FIG. 6A is a diagram illustrating an example of a signature before a signature optimization process according to an embodiment of the present invention is performed, and

FIG. 6B is a diagram illustrating the signature illustrated in FIG. 6A after the signature optimization process is performed according to an embodiment of the present invention.

### DETAILED DESCRIPTION OF THE INVENTION

The present invention will now be described more fully with reference to the accompanying drawings, in which exemplary embodiments of the invention are shown.

For convenience of explanation, a method of generating a signature according to an embodiment of the present invention will be referred to as an optimizing set of signatures (OS2) method.

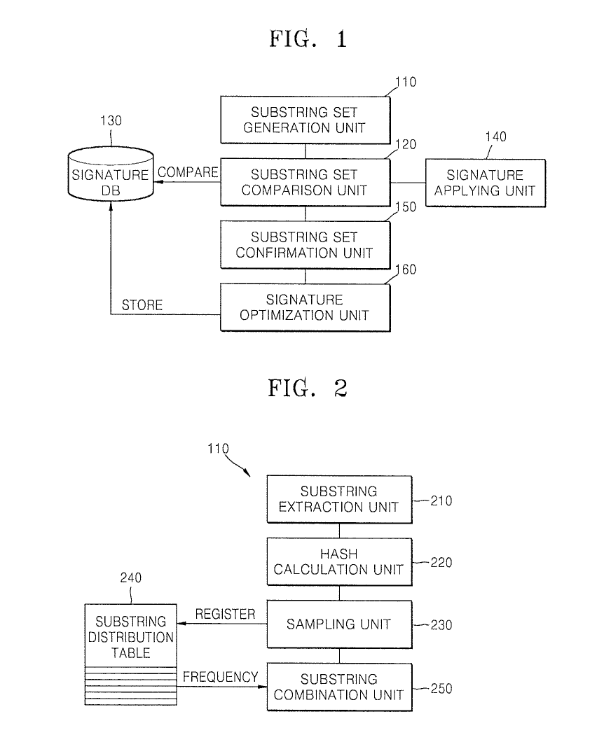

FIG. 1 is a diagram illustrating a major structure of an apparatus for automatically generating an optimum signature according to an embodiment of the present invention.

Referring to FIG. 1, the apparatus for automatically generating an optimum signature is composed of a substring set generation unit 110, a substring set confirmation unit 150 and a signature optimization unit 160.

The major elements and operation flow of the apparatus will now be described. First, the substring set generation unit 110 generates a substring set that is regarded as attacking contents in a packet that are an object of examination. A substring set comparison unit 120 compares the generated substring set with existing signatures. If the generated substring set is already registered, a signature application unit 140 applies a security policy corresponding to the substring set. If the set is not registered, the substring set confirmation unit 150 verifies whether or not the generated substring set has a characteristic as a signature. The verified substring set, that is, the signature, is optimized in the signature optimization unit 160 and is registered in a signature database (DB) 130.

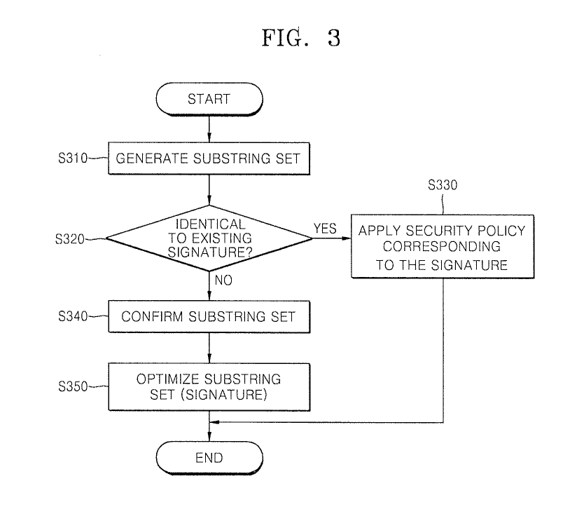

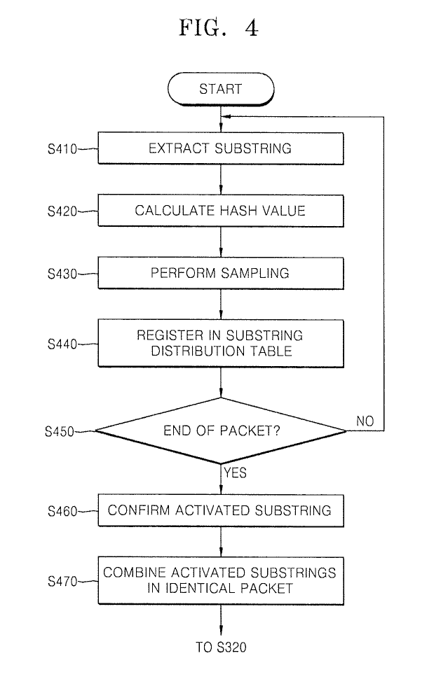

The substring set generation unit 110 combines substrings that appear more frequently than a predetermined number of times from among a plurality of substrings extracted from the packet, thereby generating a substring set. A detailed structure of the substring set generation unit 110 and a method of generating a substring set will be explained in more detail later with reference to FIGS. 2 and 4.

The substring set confirmation unit 150 examines the attacking characteristic of a packet having the substring set generating the substring set generation unit 110, thereby confirming whether or not this substring set can be used as a signature for detecting an attacking packet.

In order to achieve this, the number of destination addresses of the packet may be examined, and if the number of the destination addresses is equal to or greater than the predetermined value, the generated substring set may be determined as being the signature of an attacking packet, and used as a signature for detecting the attacking packet.

When a session success ratio of the packet is examined, if the session success ratio is equal to or less than a predetermined value, the generated substring set may be determined as being the signature of an attacking packet, and used as a signature for detecting the attacking packet.

Also, any combination (and/or) of the two criteria may be used for determination.

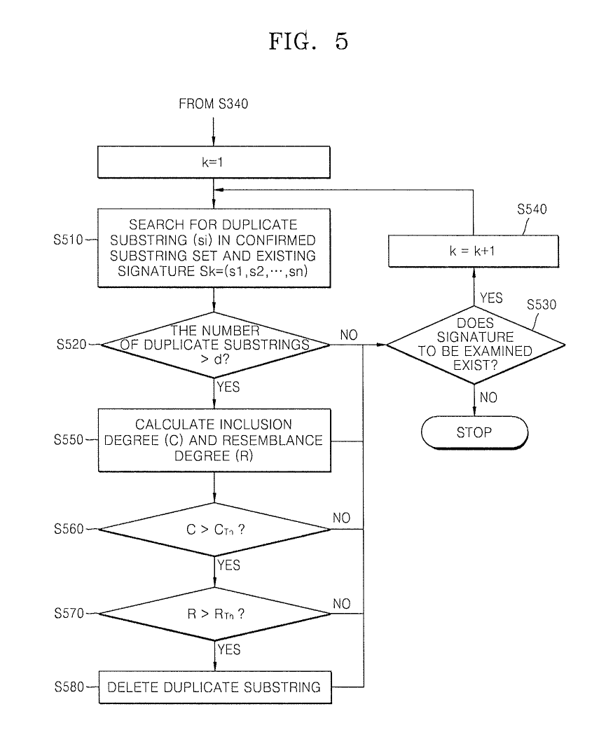

The signature optimization unit 160 minimizes the size of the confirmed substring set, i.e., the size of the signature, thereby performing optimization so as to increase the distinction and storage efficiency of a signature. The optimization method will be explained in more detail later with reference to FIG. 5.

FIG. 2 is a detailed diagram of a structure of the substring set generation unit 110 illustrated in FIG. 1 according to an embodiment of the present invention.

Referring to FIG. 2, the substring set generation unit 110 is composed of a substring extraction unit 210 extracting substrings of a predetermined length, a hash calculation unit 220 calculating hash values of extracted substrings, a sampling unit 230 sampling hash values calculated in the hash calculation unit 220, a substring distribution table 240 registering selected substrings by taking all or part of sampled hash values as indices, and a substring combination unit 250 combining substrings appearing more than a predetermined number of times from among substrings extracted from an identical packet and registered in the substring table 240, thereby generating a substring set. The method of generating a substring set in the substring set generation unit 110 will be explained in more detailed later with reference to FIG. 4.

FIG. 3 is a flowchart illustrating a method of automatically generating an optimum signature according to an embodiment of the present invention.

Referring to FIG. 3, the method of automatically generating an optimum signature includes substring set generation in operation S310, substring set confirmation in operation S320, and signature optimization in operation S350.

In the major operation flow of the method, first, a substring set regarded as attacking contents is generated in a packet that is an object of examination in operation S310. Here, substrings appearing more than a predetermined number of times are combined, from among a plurality of substrings extracted from the packet, thereby generating the substring set. The method of generating a substring set will be explained in more detailed later with reference to FIG. 4.

Then, in operation S320, the generated substring set is compared with existing signatures that are already registered. If the generated substring set is already registered, a security policy corresponding to the substring set is applied in operation S330. If the set is not registered, it is confirmed whether or not the generated substring set has a characteristic as a signature in operation S340. Here, by examining the attacking characteristic of the packet having the substring set, it is determined whether or not the substring set is to be used as a signature for detecting an attacking packet. The substring sets of packets classified as packets likely to attack are examined more precisely with respect to their behavioral characteristics. Here, the characteristics used for the examination include the distribution of destination addresses, and a session success ratio.

In this case, the number of destination addresses of the packet may be examined, and if the number of the destination addresses is equal to or greater than the predetermined value, the generated substring set may be determined as being the signature of an attacking packet, and used as a signature for detecting the attacking packet.

Also, when the session success ratio of the packet is examined, if the session success ratio is equal to or less than a predetermined value, the generated substring set may be determined as being the signature of an attacking packet, and used as a signature for detecting the attacking packet.

In addition, any combination (and/or) of the two criteria may be used for determination.

The signatures, based on the substring sets generated by the process described above, can effectively remove a part that can be incorrectly detected, such as a protocol header or a header of a predetermined application. However, when a substring set generated in relation to one packet is used for detecting attacks, the size of the signature and the number of signatures can become bigger than those of conventional methods, and it may cause degradation in the performance of a system. Accordingly, an optimization process for the signatures classified as attacking packets according to the process described above is performed.

After the optimization in which the size of each signature of the confirmed substring sets is minimized and the distinction and storage efficiency of a signature is increased, the automatic generation of signatures is completed in operation S350. The method of optimization will be explained in more detail later with reference to FIG. 5.

FIG. 4 is a detailed flowchart illustrating a method of generating a substring set according to an embodiment of the present invention.

Referring to FIG. 4, in the generation of a substring set, a series of operations, including extracting substrings having a predetermined length from a packet in operation S410, calculating hash values of the extracted substrings in operation S420, sampling the calculated hash values in operation S430, and registering selected substrings by taking all or part of the sampled hash values in operation S440, are repeatedly performed to the end of the packet. Then, substrings appearing more than a predetermined number of times from among the registered substrings are confirmed in operation S460, and activated substrings extracted from an identical packet are combined, thereby generating a substring set in operation S470.

Each process illustrated in FIG. 4 will now be explained in more detail.

First, in operation S410, substrings of a predetermined length are extracted from all packets arriving at a network device in which an object system is installed. 2 bytes to 100 bytes are generally used as the length of the substring. At this time, a continuous or discontinuous byte string having a predetermined length in a packet is used as a substring.

Then, the hash value of each extracted substring is calculated using a widely used simple hashing algorithm in operation S420.

Here, a representative method that can be used for extraction of a substring and calculation of a hash value is the Karp-Rabin fingerprinting technique described above. In this technique, one document is divided into substrings of k-byte length, and a hash value with respect to each substring is calculated. At this time, each substring is divided according to a moving window method. For example, if the first substring is formed from first byte to k-th byte, the second substring is formed from second byte to (k+1)−th byte. Here, if each byte of one substring is expressed by coefficients of a polynomial, the hash value of a continuous substring can be obtained by just a simple calculation. If the total size of a document is x bytes, the number of hash values to be generated is x−k+1, and the calculated (x−k+1) hash values represent the document.

A comparison of all the calculated hash values is a major factor in degrading the performance of a system as described above. Accordingly, the calculated hash values are sampled by using sampling methods in operation S430.

Although a variety of sampling methods can be applied, the following four methods will be explained here.

First, there is a method of determining whether or not a predetermined character string exists in the documents being compared. For this, a modulus p operation with respect to each calculated hash value is performed. Then, among the results, only a predetermined value, for example, a value having a modulus p of ‘0’, is selected for the substring set of the document. This method is simple and actually easy to apply, but it has a drawback in that the number of generated substring sets varies depending on the contents and size of a document.

As a method of compensating for this, there is a winnowing technique. In the winnowing technique, instead of selecting predetermined values occurring in the modulus p operation, a window having a predetermined size is used, thereby selecting a minimum value from among hash values corresponding to the window. In this way, a minimum number of substring sets that a document of predetermined size can have is guaranteed and a substring set can be extracted more accurately.

As a method that is a little simpler than the winnowing technique, there is a method of selecting n minimum values among hash values occurring in each document. The selected hash values are expressed as a set of values representing the document, and by comparing sets representing each document, the resemblance between documents is calculated. This method has a problem in that when a bigger document includes a smaller document, it is difficult to determine whether the two documents are similar to one another or one document is included in the other.

Finally, there is a content-based payload partitioning (COPP) method in which a predetermined value in a document is found, and a predetermined number of bytes from the position of the value, or the contents from the position of the value to a position where a character string that is desired to be found appears for a second time, are used as a fingerprint.

In the present invention, sampling may be performed using the winnowing technique. By sampling substrings according to the winnowing technique, the drawbacks of value sampling, that is, changes in the number of samples and a high frequency of a predetermined character string, can be compensated for.

A method of determining the number of samples to be extracted from one packet may be performed by determining the number of samples in proportion to the length of the packet.

The substrings selected through sampling occupy predetermined positions in the substring distribution table 240 illustrated in FIG. 2 by taking the entire or part of calculated hash values as indices, thereby increasing the frequency of the corresponding position in operation S440.

If a substring that is to be processed remains, the processes described above are repeatedly performed in operation S450.

Next, the frequency of substrings registered in the substring distribution table 240 is confirmed, thereby confirming whether a substring is an activated substring in operation S460. If substrings are extracted from an identical packet, substrings appearing more than a predetermined number of times are combined, thereby generating a substring set in operation S470. That is, based on the frequency of a substring registered in the substring distribution table 240 and a preset threshold, substrings appearing more than the predetermined number of times are determined as substrings that are likely to attack a network, and a combination of the substrings is used to generate a substring set.

Registered substrings are divided into active substrings and inactive substrings according to their frequencies. At this time, the criterion for classifying the substrings is determined according to the frequencies in the substring distribution table 240 and the preset threshold.

Methods of determining the threshold include a method using an average frequency of entire substrings, and a method of setting a threshold using a highest frequency of a substring recorded at a predetermined time in the case of normal packets by means of experiments. The method using an average frequency further includes a method of obtaining the average of i latest substrings by using an exponentially weighted moving average, and a method using an arithmetic average of entire substring frequencies.

For example, when the average of the entire substrings is Aavg, a threshold Ath is β*Aavg (where β is a real number greater than 1), and if the frequency of a selected substring is greater than the threshold Ath, the substring is classified as an active substring.

Assuming that the total number of active substrings that are generated with respect to one packet, and are sampled and registered in the substring distribution table 240, and whose frequencies are greater than the threshold Ath is Na, then if Na is greater than a predefined threshold number (Sth) of substrings (where Sth is an integer greater than 1), the packet is classified as a packet that is likely to attack, and the Na substrings generated from the packet are stored in a separate space and combined as a substring set in operation S470.

In the current embodiment illustrated in FIG. 4 as described above, the operation S450 for repeatedly examining up to the end of the packet is disposed between the operation S440 for registering in the substring distribution table 240 and the operation S460 for confirming activated substrings. In this case, since activated substrings should be confirmed after one packet is completely processed, when the substring distribution table 240 is updated, a flag indicating a recently processed packet should be disposed.

However, in another embodiment, it can be made that after the operation S470 for combining activated substrings in an identical packet, repetitive examination is performed. In this case, even without the flag, it can be immediately determined that a substring is an activated substring occurring in a packet being currently examined.

FIG. 5 is a flowchart illustrating a method of optimizing a signature according to an embodiment of the present invention.

Referring to FIG. 5, a confirmed substring set, that is, a newly generated signature, is compared with each other signature stored in advance, and common substrings in the comparison are deleted, thereby optimizing the signature.

The major purpose of the signature optimization is to prevent degradation of the distinction of a signature that can occur when a hash value is used to generate signatures, thereby minimizing incorrect detection. That is, if part of a generated signature includes a part that is commonly used in a plurality of packets, as the header or a protocol or application, system resources, such as a storage space required for storing a signature and processing power required for applying a signature, are unnecessarily used, thereby degrading the performance of the system. Accordingly, technology for increasing the efficiency of a system by removing a part included in a plurality of signatures is signature optimization.

For this, all extracted signatures are examined as to whether or not a substring included in each signature is included in another signature in operation S510. That is, regarding a signature that is a substring set, as a set, and regarding substrings forming the substring set, as elements of the set, a comparison is made in order to determine whether or not common elements (substrings) exist.

At this time, considering a collision of a hashing function and scalability, the number of duplicate substrings appearing may be limited to d in operation S520. That is, in the optimization process, only when one substring occurs in d or more than d signatures, the corresponding substring is deleted from each signature.

If the number of duplicate substrings is equal to or less than the preset value d, it is confirmed whether or not existing signatures available for comparison remain in operation S530, and the processes for the next signature is repeated in operation S540.

Meanwhile, if deletion is performed in this way, a case where attacking signatures, which have a different part that is a very small part, are all deleted in continuously generated attacking signatures, may occur. For example, in the case of the polymorphic worm, which changes part of an attacking code little by little in each attack attempt, if the duplicate part is all deleted, only a very small part that is different remains. This shows a characteristic similar to a signature generated in a system for detecting an attack by using only one substring as in the Earlybird technique described above. Accordingly, this undermines the advantages of the present invention.

In order to prevent this, a method may be used in which if one signature is included in another signature or is similar to another signature by more than a predetermined level, deletion is not performed.

First, the inclusion degree (C) and resemblance degree (R) are calculated between signatures in operation S550. For the inclusion degree (C) and the resemblance degree (R), a concept that is usually employed in set theory is used. That is, with respect to two sets (signatures) A and B, the degree (C) to which set A is included in set B is calculated according to equation 1 below:

$$C ( A , B ) = \frac{A ⋂ B}{A} \qquad ( 1 )$$

Also, the resemblance (R) between sets A and B is calculated according to equation 2 below:

$$R ( A , B ) = \frac{A ⋂ B}{A ⋃ B} \qquad ( 2 )$$

That is, when the inclusion degree (C) of the two signatures is less than a threshold value Cth predetermined according to the characteristic of a security system in operation S560, and when the resemblance degree (R) of the two signatures is less than a threshold value Rth predetermined according to the characteristic of the security system in operation S570, the duplicate substring can be deleted from the two signatures in operation S580.

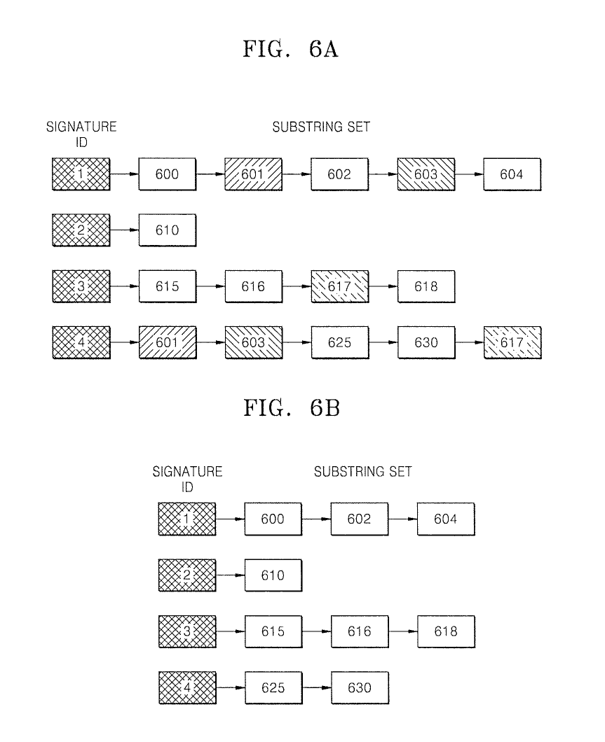

FIG. 6A is a diagram illustrating an example of a signature before a signature optimization process, according to an embodiment of the present invention, is performed, and FIG. 6B is a diagram illustrating the signature illustrated in FIG. 6A after the signature optimization process is performed, according to an embodiment of the present invention.

In this example, it is assumed that 1 is used as a variable d indicating the duplication degree of a substring forming a signature, and 0.5 is used for both Rth and Cth.

For example, a case where signatures 1, 2, and 3 are sequentially generated and signature 4 is, at present, newly registered will now be explained. Here, the signature 4 has substrings 601, 603, 625, 630, and 617 (substrings registered in one signature may be sorted for convenience of operations that are to be required later, but it may be a cause of incorrect detection when detecting an attack, and therefore, the substrings are not sorted in the current embodiment). Among the substrings, substrings 601 and 603 overlap the substrings of signature 1. Also, substring 617 overlaps the substring of signature 3. This means that the newly generated signature 4 has common parts with existing signatures 1, 2, and 3, and the newly generated signature 4 has a weak distinction.

In this example, since d is 1, the conditions for the operation S520 illustrated in FIG. 5 is satisfied. When the inclusion degree (C) and the resemblance degree (R) are calculated, in the case of signatures 1 and 4, the inclusion degree (C) is ⅖=0.4, the resemblance degree (R) is 2/8=0.25, and in the case of signatures 3 and 4, the inclusion degree (C) is ¼=0.25 and the resemblance degree (R) is ⅛=0.125. Accordingly, these degrees are less than Rth and Cth, both of which are assumed to be 0.5, and substrings 601, 603, and 617 are all deleted. The deleted result is illustrated in FIG. 6B.

The technology for expressing the inclusion degree and the resemblance degree, which are used in the signature optimization, as numbers, can also be used for detecting an attack using a signature. In the case of the polymorphic worm, the contents of the packet may vary little by little in each attack. In this case, if conventional exact pattern matching is used, incorrect detection may occur. However, when the technology for expressing the inclusion degree and the resemblance degree as numbers, as described above, is used, if an unchanged part is included in a packet even when part of the contents of the packet has changed, the packet can be detected as an attacking packet.

The method of the present invention as described above may be implemented as a program and can be used as a part of a network router or a part of security device of a network. Also, the method of the present invention can be implemented as a hardware method, for example, as an application-specific integrated circuit (ASIC) and a field programmable gate array (FPGA), in order to be used in an ultra high speed network.

According to the present invention, an attacking packet occurring in a high speed network is detected, and its signature is automatically generated, thereby protecting the network from an attack that may occur later.

Also, according to the present invention, instead of a pattern occurring in a part of a packet, a group of patterns occurring in a plurality of parts of the packet is used as an attacking signature, thereby minimizing incorrect detection. Also, the signature is optimized, thereby enabling the establishment of a security system in which generation, storage, management, and application of the signature is simplified.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for automatically generating an optimum signature for a security system, the apparatus comprising:
a substring set generation unit combining substrings appearing more than a predetermined number of times from among a plurality of substrings extracted from packets;
a substring set confirmation unit examining whether or not a packet having the substring set has a characteristic of an attacking packet, and confirming whether or not the substring set can be used as a signature for detecting an attacking packet; and
a signature optimization unit minimizing the size of the confirmed substring set, and increasing distinction and storage efficiency of the substring set as a signature.

2. The apparatus of claim 1, wherein the substring set generation unit comprises:
a substring extraction unit extracting substrings of predetermined length from the packets;
a hash calculation unit calculating a hash value of each extracted substring;
a sampling unit sampling the hash values calculated in the hash calculation unit;
a substring distribution table registering the selected substrings by taking all or part of the sampled hash values as indices; and
a substring combination unit combining substrings appearing more than a predetermined number of times from among the substrings extracted from the identical packet and registered in the substring distribution table, thereby generating a substring set.

3. The apparatus of claim 2, wherein the substring set extraction unit extracts a byte string of predetermined length in the packets.

4. The apparatus of claim 2, wherein the hash calculation unit calculates the hash value by using a Karp-Rabin fingerprinting method.

5. The apparatus of claim 2, wherein the sampling unit determines the number of samples to be extracted from one packet to be in proportion to the length of the packet.

6. The apparatus of claim 2, wherein the sampling unit performs sampling by using a winnowing technique.

7. The apparatus of claim 2, wherein the substring combination unit determines substrings appearing more than a predetermined number of times as substrings that are likely to attack a network, based on the frequencies of the substrings registered in the substring distribution table and a preset threshold, and combines the substrings that are deemed to attack a network.

8. The apparatus of claim 7, wherein the threshold is set by using the average frequency of the entire substrings.

9. The apparatus of claim 7, wherein the threshold is set by using a highest frequency of a substring recorded at a predetermined time.

10. The apparatus of claim 1, wherein the substring set confirmation unit examines the number of destination addresses of the packets having the substring set, and if the number of destination addresses is equal to or greater than a predetermined value, the substring set confirmation unit confirms that the substring set is used as a signature.

11. The apparatus of claim 1, wherein the substring set confirmation unit examines a session success ratio of the packets having the substring set, and if the session success ratio is equal to or less than a predetermined value, the substring set confirmation unit confirms that the substring set is used as a signature.

12. The apparatus of claim 1, wherein the signature optimization unit compares the confirmed substring set with other already stored signatures, and deletes common substrings.

13. The apparatus of claim 12, wherein only when at least one of an inclusion degree and a resemblance degree between the confirmed substring set and the other already stored signatures are equal to or less than a predetermined value, the signature optimization unit delete the common substrings.

14. The apparatus of claim 1, further comprising a substring set comparison unit comparing the substring set generated in the substring set generation unit with each already stored existing signature in order to determine whether or not the two are the same.

15. A method of automatically generating an optimum signature for a security system, the method comprising:
combining substrings appearing more than a predetermined number of times from among a plurality of substrings extracted from packets, and generating a substring set;
examining whether or not a packet having the substring set has a characteristic of an attacking packet, and confirming whether or not the substring set can be used as a signature for detecting an attacking packet; and
minimizing the size of the confirmed substring set, and increasing distinction and storage efficiency of the substring set as a signature, for optimization.

16. The method of claim 15, wherein the generating of the substring set comprises:
extracting substrings of predetermined length from the packets;
calculating a hash value of each extracted substring;
sampling the calculated hash values;
registering the selected substrings by taking all or part of the sampled hash values as indices; and
combining substrings extracted from the identical packet and appearing more than a predetermined number of times from among the registered substrings, thereby generating a substring set.

17. The method of claim 16, wherein in the extracting of the substrings, a byte string of predetermined length in the packet is extracted while performing a hashing method.

18. The method of claim 16, wherein in the calculation of the hash value, the hash value is calculated by using a Karp-Rabin fingerprinting method.

19. The method of claim 16, wherein in the sampling of the calculated hash values, the number of samples to be extracted from one packet is determined to be in proportion to the length of the packets.

20. The method of claim 16, wherein in the sampling of the calculated has values, the sampling is performed by using a winnowing technique.

21. The method of claim 16, wherein in the combining of the substrings, substrings appearing more than a predetermined number of times is determined as substrings that are likely to attack a network, based on the frequencies of the substrings registered in the substring distribution table and a preset threshold, and the substrings that are deemed to attack a network are combined.

22. The method of claim 21, wherein the threshold is set by using the average frequency of the entire substrings.

23. The method of claim 21, wherein the threshold is set by using a highest frequency of a substring recorded at a predetermined time.

24. The method of claim 15, wherein in the confirming of the substring set, the number of destination addresses of the packet having the substring set is examined, and if the number of the destination addresses is equal to or greater than a predetermined value, it is confirmed that the substring set is used as a signature.

25. The method of claim 15, wherein in the confirming of the substring set, a session success ratio of the packets having the substring set is examined, and if the session success ratio is equal to or less than a predetermined value, it is confirmed that the substring set is used as a signature.

26. The method of claim 15, wherein in the optimization of the signature, the confirmed substring set is compared with other already stored signatures, and common substrings are deleted.

27. The method of claim 26, wherein in the optimization of the signature, only when at least one of an inclusion degree and a resemblance degree between the confirmed substring set and the other already stored signatures are equal to or less than a predetermined value, the common substrings are deleted.

28. The method of claim 15, further comprising comparing the substring set generated in the substring set generation unit with each already stored existing signature in order to determine whether or not the two are the same.
